SEQUENCE LISTING (6 sequences)

SEQ ID NO: 1 - DNA, 22 bp, Artificial Sequence
  Chemically synthesized synthetic construct
cgccgattggacaaaacttaaa

SEQ ID NO: 2 - DNA, 22 bp, Artificial Sequence
  Chemically synthesized synthetic construct
cgccgattggagaaaacttaaa

SEQ ID NO: 3 - DNA, 22 bp, Artificial Sequence
  Chemically synthesized synthetic construct
tttaagttttgtccaactggcg

SEQ ID NO: 4 - DNA, 22 bp, Artificial Sequence
  Chemically synthesized synthetic construct
tttaagttttgtccaatcggcg

SEQ ID NO: 5 - DNA, 22 bp, Artificial Sequence
  Chemically synthesized synthetic construct
tttaagttttgtccaatcggcg

SEQ ID NO: 6 - DNA, 22 bp, Artificial Sequence
  Chemically synthesized synthetic construct
cgccgattggacaaaacttaaa

(19) United States
(12) Patent Application Publication
(10) Pub. No.: US 2008/0274917 A1
(43) Pub. Date: Nov. 6, 2008

(54) Surface activation methods for polymeric substrates to provide biochip platforms and methods for detection of biomolecules thereon

(75) Inventors: Hua-Zhong Yu, Burnaby (CA); Yunchao Li, Burnaby (CA); Zhen Wang, Guangdong (CN); Lily M.L. Ou, Coquitlam (CA)

Correspondence Address: CROMPTON, SEAGER & TUFTE, LLC, 1221 NICOLLET AVENUE, SUITE 800, MINNEAPOLIS, MN, 55403-2420, US

(73) Assignee: Simon Fraser University, Burnaby (CA)

(21) Appl. No.: 12/006,072

(22) Filed: Dec. 28, 2007

Related U.S. Application Data
(60) Provisional application No. 60/882,392, filed on Dec. 28, 2006.
(60) Provisional application No. 60/878,770, filed on Jan. 5, 2007.

(51) Int. Cl. C40B 50/18

(52) U.S. Cl. 506/32

(57) ABSTRACT

A surface activation method is provided to convert polycarbonate (PC) substrates, e.g., plastic bases of optical discs, to biochip platforms. Such surface activation methods comprise providing an ozone enriched environment in a vicinity of the surface and irradiating the surface with UV radiation. Once activated, the surfaces can be used for DNA probe immobilization and target detection or other bioassays.

### RELATED APPLICATIONS

This application claims the benefit of the priority of U.S. Application No. 60/882,392 filed Dec. 28, 2006 and U.S. Application No. 60/878,770 filed Jan. 5, 2007, both of which are hereby incorporated herein by reference.

### TECHNICAL FIELD

The invention described herein relates to surface activation of polymeric substrates. Particular embodiments provide methods for surface activation of polycarbonate substrates suitable for production of biochip platforms and detection of DNA and/or other biomolecules thereon.

### BACKGROUND

Chip-based biosensors, such as DNA microarrays for example, have attracted increasing interest due to the many benefits of device miniaturization and parallel biomedical analysis. Such biosensors have typically been fabricated on glass, silicon or noble metal surfaces. Synthetic polymers may provide alternative substrates because of their low specific gravity, high elasticity and low cost. In the past, nylon membranes have been used to make DNA microarrays. Such nylon membranes suffer from the drawback that they exhibit lateral wicking characteristics, and attached DNA probes tend to spread from the points of immobilization. Other surface modification methods that involve comprehensive organic synthesis and fabrication steps, such as using graft polymer coating on silicon or gold surfaces, have been recently reported. Polycarbonate (PC) is an important thermoplastic because of its high optical clarity, tensile elongation and impact strength in comparison to many other materials. PC forms the base material for the manufacture of machine-readable optical discs (e.g. CDs, DVDs and the like), which are typically fabricated using inexpensive injection molding processes. In addition to being popular information storage media, optical discs have proven to be versatile tools/platforms for materials chemistry and biomedical research (see References 7-17). For example, Madou and co-workers have focused their efforts on the fabrication of microfluidic devices on circular plastic discs, which integrate microfluidic functions with CD technology, particularly the control of fluid transfer by disc spinning (see References 8 and 9) Several organizations, including Burstein Technologies, Gyros AB, and Tecan, have been working on the commercialization of similar devices; the Swedish firm Amic AB provides special optical disc fabrication services (e.g. preparation of high-precision masks and development of replication techniques).

Surface activation refers generally to procedures that convert relatively chemically inert surfaces of solid materials to be relatively reactive toward biomolecules of interest. In the past, the activation of polymer surfaces has relied primarily on prolonged ultraviolet (UV) irradiation. Liu et al. irradiated PC with a UV lamp (4 W, 220 nm, 5 hours exposure) to improve the aqueous fluid transport in microchip capillary electrophoresis devices and to facilitate the DNA probe attachment to different plastic substrates (polystyrene (PS), PC, poly(methylmethacrylate) (PMMA) and polypropylene) in microfluidic channel arrays (see References 28 and 29). Welle and Gottwald studied the effects of UV irradiation (low pressure 15-W UV lamp, at 185 and 254 nm) of PS, PMMA and PC on cell adhesion in vitro (see Reference 30). McCarley and co-workers prepared polymer-based microanalytical devices by “mild” UV activation (15 mW/cm² at 254 nm) of PMMA and PC, and described their surface characteristics in detail (see References 31, 32 and 33). Recently, Kimura reported a simple, direct immobilization method: UV-induced attachment of poly(dT)-modified DNA strands to PC, PMMA, and polyethylene terephthalate (PET)—see Reference 34. These studies have demonstrated that UV light successfully converts PMMA to a bioreactive substrate with a high surface density of functional groups, leading to satisfactory results for DNA immobilization/hybridization. In contrast, only limited success has been achieved for PC, primarily. Without wishing to be bound by any particular theory, the prior art suggests that the limited success of activating PC substrates may be because of the low surface density of reactive groups, auto-fluorescence, and/or strong non-specific adsorption (see References 29, 31 and 32).

In view of the above, there is a general desire to provide methods for surface activation of PC substrates. Such methods may be used to convert PC substrates to polymeric platforms for the fabrication of chip-based biosensing devices, such as DNA microarrays, for example.

### SUMMARY

One aspect of the invention provides methods for surface activation of a surface comprising polymer chains. The methods comprise providing an ozone enriched environment in a vicinity of the surface and irradiating the surface with UV radiation.

Another aspect of the invention provides methods for conducting a biological assay on a surface. The method comprises: activating the surface by providing an ozone enriched environment in a vicinity of the surface and irradiating the surface with UV radiation; after activating the surface, allowing a first substance to react with molecules on the surface, thereby immobilizing the first substance on the surface; after immobilizing the first substance on the surface, allowing a second substance to come into contact with surface; and ascertaining whether there is a chemical reaction between the first and second substances.

Another aspect of the invention provides methods for the activation of PC substrates (such as the plastic bases of optical discs, for example). PC substrates can be readily converted to a polymeric platform for the fabrication of chip-based biosensing devices (DNA microarrays, for example) by treatment of the PC substrate using a combination of UV radiation and ozone reaction. The surface activation methods may be relatively rapid (less than 10 min) and efficient (yielding a high surface density of —COOH) when compared to prior art surface activation techniques used on PC. In comparison to prior art surface activation techniques, surface activation using the combination of UV radiation and ozone reaction is relatively non-destructive (i.e. the surface morphology of the PC substrate is not substantially altered).

Another aspect of the invention provides methods for fabricating bioanalytical devices by direct immobilization of DNA probes via photo-patterning/coupling reactions and by creating hybridization microarrays with microfluidic channel plates. The fabrication procedure (activation, patterning, and coupling) is simple and effective, and the resultant hybridization is highly sensitive and selective. Both passive and flow-through immobilization/hybridization experiments with various DNA probe-target complements have successfully detected single base-pair mismatches and reduced non-specific adsorption.

Methods described herein extend beyond the exemplary applications presented in this document. For example, the methods described herein are potentially useful for the development of disposable plastic biochips and the fabrication of biomedical devices that are readable with conventional CD drives.

Other features and aspects of specific embodiments of the invention are described below.

### BRIEF DESCRIPTION OF THE DRAWINGS

In drawings, which illustrate features of non-limiting embodiments of the invention:

FIGS. 1A and 1B respectively show schematic depictions of the chemical structure of polycarbonate (PC) and a potential reaction methodology for PC surface activation by combining UV irradiation in the presence of ozone according to a particular embodiment of the invention according to a particular embodiment of the invention;

FIG. 2A shows a plot of experimental data depicting a water contact angle at a PC surface versus treatment time for a PC substrate subjected to a particular implementation of a surface activation method combining UV irradiation in the presence of ozone according to a particular embodiment of the invention;

FIG. 2B shows a plot of experimental data depicting a water contact angle at a PC surface versus treatment time for a PC substrate subject to a prior art surface activation method using UV irradiation alone (i.e. without ozone);

FIG. 3A shows a plot of experimental data depicting a water contact angle at a PC surface versus storage (aging) time after initial activation via a particular implementation of a surface activation method combining UV irradiation in the presence of ozone according to a particular embodiment of the invention;

FIG. 3B shows a plot of experimental data depicting a water contact angle at a PC surface versus storage (aging) time after initial activation via a prior art surface activation method using UV irradiation alone (i.e. without ozone);

FIG. 4 shows a plot of experimental data depicting a water contact angle at a PC surface versus pH for a PC substrate subjected to a particular implementation of a surface activation method combining UV irradiation in the presence of ozone according to a particular embodiment of the invention (open circles) and for an untreated PC substrate (filled in circles);

FIG. 5A shows an atomic force microscope (AFM) image of a PC surface before being subjected to surface activation and FIG. 5B shows a plot of the height of the FIG. 5A PC surface along a linear scan thereof;

FIG. 5C shows an AFM image of a PC surface after being subjected to a particular implementation of a surface activation method combining UV irradiation in the presence of ozone according to a particular embodiment of the invention and FIG. 5D shows a plot of the height of the FIG. 5C PC surface along a linear scan thereof;

FIG. 6A depicts a fluorescence images of a PC surface subjected to a particular implementation of a surface activation method combining UV irradiation in the presence of ozone according to a particular embodiment of the invention prior to modification of the activated PC surface by hybridization of DNA probe strands with fluorescein-labeled DNA targets;

FIGS. 6B, 6C and 6D respectively depict fluorescence images of PC surfaces subjected to a particular implementation of a surface activation method combining UV irradiation in the presence of ozone according to a particular embodiment of the invention and modified by hybridization of DNA probe strands with fluorescein-labeled DNA targets for the cases of: complementary probe and target strands; non-complementary probe and target strands; and single-base mismatch probe strands and target strands;

FIG. 7 is a plot depicting the relative fluorescence intensities of the PC surfaces in FIGS. 6A-6D;

FIG. 8 is a schematic representation of a method for creation of DNA hybridization arrays using microchannel plates on a PC substrate subjected to a surface activation method combining UV irradiation in the presence of ozone according to a particular embodiment of the invention;

FIG. 9A depicts experimental data showing the relative fluorescence intensity of DNA probe lines prepared by delivering substantially identical volume samples of marker strands to a PC substrate subjected to a particular implementation of a surface activation method combining UV irradiation in the presence of ozone according to a particular embodiment of the invention, wherein the marker strands are delivered using microchannel plates and each line represents a different marker strand concentration;

FIG. 9B is a plot of experimental data showing fluorescence intensity versus marker concentration for the FIG. 9A data and the FIG. 9B inset is a plot of experimental data showing the FIG. 9A fluorescence intensity along a linear scan thereof;

FIGS. 10A and 10B show experimentally obtained fluorescence intensity images of hybridizations of a complementary DNA probe and target using different hybridization buffer solutions on a PC surface subjected to a particular implementation of a surface activation method combining UV irradiation in the presence of ozone according to a particular embodiment of the invention;

FIG. 10C is a plot of experimentally obtained fluorescence intensity versus target concentration for a complementary DNA probe and target using the same hybridization buffer solution used to obtain the FIG. 10B data;

FIG. 11A depicts experimental data showing the relative fluorescence intensity of DNA hybridization processes conducted on a PC substrate subjected to a surface activation method combining UV irradiation in the presence of ozone according to a particular embodiment of the invention, wherein probe lines 5-7 were obtained with complementary probes, line 4 was obtained with non-complementary probes and lines 1-3 were obtained with strands containing a single base-pair mismatch;

FIG. 11B is plot of experimental data showing fluorescence intensity versus position along the scan line shown in FIG. 11A;

FIG. 12 depicts plots showing the XPS (X-ray photoelectron spectroscopy) C 1S and O 1S signals of a PC substrate before (filled in circles) and after (inverted triangles) UV irradiation in the presence of ozone according to a particular embodiment of the invention and UV irradiation in the presence of ozone through a TEM grid (open circles) for 10 minutes;

FIG. 13 is a schematic description of a DNA immobilization/hybridization experiment conducted on a PC surface subjected to a surface activation method combining UV irradiation in the presence of ozone according to a particular embodiment of the invention;

FIG. 14 is a plot showing experimental results of a distribution of fluorescence intensity in a 7×7 array resulting from the hybridization of Probe I and Target II corresponding to the data shown in FIG. 10B; and

FIG. 15 is a plot showing a comparison of the fluorescence intensities and spot sizes resulting from the hybridization of Probe I and Target II on two different surfaces subject to the same conditions.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

Particular embodiments of the invention provide methods for activating polycarbonate (PC) surfaces which involve irradiating the PC surface with UV radiation in the presence of ozone (O₃) so as to cause a reaction between the irradiated PC surface and the ozone. The ozone may be present at the reaction site in a concentration greater than a concentration threshold. The ozone concentration threshold is greater than the ozone concentration at the surface of the earth (i.e. on the order of ˜0.3 ppm). In some embodiments, the ozone concentration is greater than 10 ppm. In some embodiments, the ozone concentration is greater than 20 ppm. In some embodiments, the ozone concentration may be higher.

The PC substrate may be irradiated at a UV radiation level of intensity level sufficiently low to avoid damaging the irradiated surface. In some embodiments, the radiation intensity is less than about 50 mW/cm². In other embodiments, the radiation intensity is less than about 20 mW/cm². In some embodiments, the UV radiation intensity may be lower.

Aspects of the invention also provide methods for producing biochip platforms on PC surfaces activated by UV radiation in the presence of ozone and for detection of DNA and/or other biomolecules thereon. Particular embodiments of the invention provide methods for photopatterning PC surfaces and for passive and/or microfluidic DNA immobilization/hybridization thereon. PC surfaces may be provided by standard optical discs (e.g. CDs, DVDs or the like). In some embodiments, DNA immobilized and/or hybridized on the PC surfaces of such optical discs according to the invention may be read in standard optical disc drives. Surface Activation and Characterization. In accordance with one particular embodiment of the invention, the PC base of an optical disc (or other suitable PC substrate) is activated by: (i) irradiation with UV radiation; and (ii) reaction with ozone. Preferably, ozone is present at the reaction site (i.e. at or near the PC surface) in a concentration greater than a concentration threshold. The ozone concentration threshold is greater than the ozone concentration at the surface of the earth (i.e. on the order of ˜0.3 ppm). In some embodiments, the ozone concentration is greater than 10 ppm. In some embodiments, the ozone concentration is greater than 20 ppm. In some embodiments, the ozone concentration may be higher.

The PC substrate may be irradiated at a UV radiation level of intensity level sufficiently low to avoid damaging the irradiated surface. In some embodiments, the radiation intensity is less than about 50 mW/cm². In other embodiments, the radiation intensity is less than about 20 mW/cm². In some embodiments, the UV radiation intensity may be lower.

Ozone may be introduced to the reaction site in any suitable manner. In some embodiments, UV radiation is used both to create ozone from O₂ which may be present at the reaction site (e.g. by photolysis of molecular oxygen (O₂)) and to irradiate the PC surface. Such UV radiation may be provided at different wavelengths (i.e. one wavelength that tends to promote the formation of ozone from molecular oxygen (O₂) and a second wavelength that tends to promote the activation reaction at the PC surface. In other embodiments, ozone may be introduced to the reaction site by a secondary ozone source. By way of non-limiting example, a suitable secondary ozone source is the OZO-2VTT ozone generator sold by Ozomax, Inc. of Shefford, Quebec, Canada) and to provide the independently generated ozone in the presence of the PC surface.

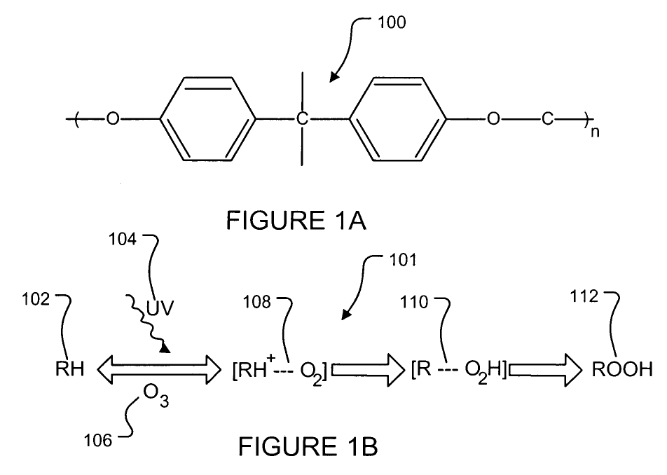

FIG. 1A shows a schematic depiction of the chemical structure of PC. More specifically, FIG. 1A schematically depicts one unit 100 of the PC polymer chain, where the brackets “( )” and the letter n are used to indicate that there may generally be any number of units 100 in a particular PC polymer chain. Without wishing to be bound by theory, FIG. 1B shows a schematic depiction of a potential reaction methodology 101 for PC surface activation by combining UV irradiation in the presence of ozone according to a particular embodiment of the invention.

In accordance with reaction methodology 101, PC (represented using the notation RH to indicate a hydrogen site on the PC molecule and using the reference numeral 102) is irradiated with UV 104 in the presence of ozone 106. At wavelengths between 254 and 300 nm, PC is known to undergo a photo-Fries reaction that results in the formation of phenyl salicylates and hydroxybenzophenones. The presence of ozone may induce the formation an O₂-contact charge transfer complex (adduct 108), which is the initial step in the photo-oxidation of aliphatic and aromatic alkenes. Together, UV irradiation 104 and ozone 106 are thought to cause the formation of the adduct 108, where the notation “---” is used to refer to bonding between the carbon and oxygen atoms in these intermediate states. Adduct 108 is then thought to reassemble itself to forms a carboxylic group via a series of hydroperoxide intermediates. In the particular reaction mechanism shown in FIG. 1B, adduct 108 reassembles itself to form secondary intermediate 110 and ultimately to form the carboxylic acid group 112 on the PC surface.

In one particular exemplary embodiment of the invention for which experimental data has been obtained, the UV radiation was provided at about 1.5 mW/cm² at 185 nm and at about 13.2 mW/cm² at 254 nm (for a total combined UV radiation at about 15 mW/cm²) and the steady state ozone concentration was determined to be in a nominal range of approximately 25-75 ppm. It should be understood that these radiation wavelengths, radiation wavelengths and ozone concentrations are particular to the experimental apparatus and that other wavelengths, intensity levels and ozone concentrations could be used. In this exemplary embodiment, the low wavelength UV radiation (185 nm) is thought to cause the photolysis of molecular oxygen (O₂) to form ozone at or near the PC surface and the higher wavelength UV radiation (254 nm) is thought to promote the surface activation reaction (e.g. reaction 101) at the PC surface. In some embodiments, the wavelength of UV radiation used to promote the generation of ozone from molecular oxygen (O₂) is less than 240 nm and the wavelength of UV radiation used to promote the reaction mechanism shown in FIG. 1B.

UV radiation at the intensity level of about 15 mW/cm² is generally considered to be “low power” or “mild” in comparison to prior art surface activation techniques as radiation at this intensity level does not cause significant damage to the irradiated PC surface. It will be appreciated by those skilled in the art that increasing the UV radiation intensity may increase the reaction rate at the PC surface (i.e. decreasing the time required to achieve a desired surface activation level), but if the UV radiation intensity is too high, there may be damage to the PC surface. This represents an engineering trade-off which may be tailored to suit particular applications.

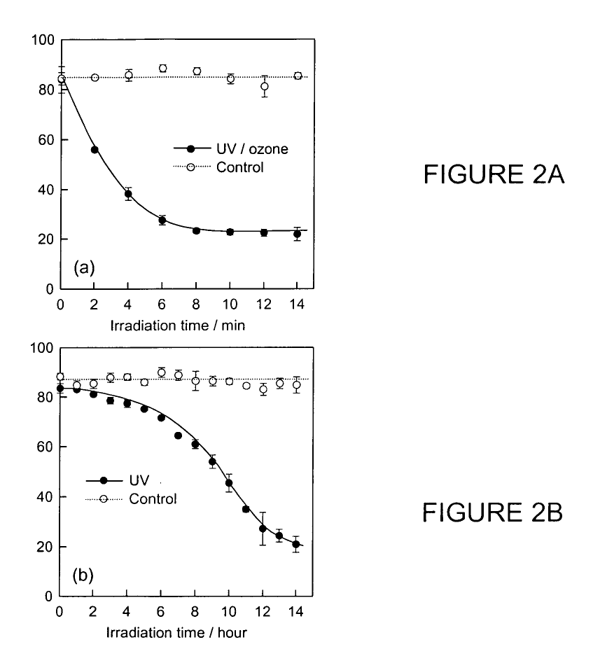

FIG. 2A shows experimental results for a particular implementation of a method for PC surface activation wherein the UV radiation was provided at about 15 mW/cm² at 185 nm and 254 nm and the steady state ozone concentration was determined to be in a nominal range of approximately 25-75 ppm and FIG. 2B shows corresponding results for the prior art method of UV radiation (at 254 nm and 6.1 mW/cm²) without enriching the ozone concentration at the PC surface. Comparing FIGS. 2A and 2B shows that irradiation with UV radiation and reaction with ozone is relatively efficient (in terms of both the rate and magnitude of surface property changes) when compared to prior art activation techniques which involve UV irradiation alone (i.e. without ozone).

FIGS. 2A and 2B show experimental results for the dependence of water contact angle at a PC surface versus time for UV radiation coupled with ozone reaction (FIG. 2A) and for conventional UV radiation without ozone reaction (FIG. 2B). While surface activation itself is not easily measurable, the decrease of water contact angle is an indication of surface activation, i.e., the magnitude of water contact angle change is correlated to the degree of surface activation. As shown in FIG. 2A, application of UV radiation in combination with ozone reaction causes the water contact angle of the PC substrate to drop from 88±2° to 20±2° after less than 10 min and to remain relatively constant at about 20±2° thereafter. It can be seen from FIG. 1B that achieving a comparable water contact angle (surface activation) using the prior art process of UV alone takes more than 10 hours. In some embodiments, the surface activation methods of the present invention comprise irradiating the PC surface in the presence of ozone for a period of time less than 1 hour. In some embodiments, the surface activation methods of the present invention comprise irradiating the PC surface in the presence of ozone for a period of less than ½ hour.

A surface with a relatively low water contact angle may be said to be relatively hydrophilic, whereas a surface with a relatively high water contact angle may be said to be relatively hydrophobic. Reported reaction durations for using UV radiation alone (i.e. without ozone enrichment) to obtain hydrophilic PC surfaces vary significantly (from 60 min to more than 10 hrs), depending, for example, on the wavelength, power, and separation distance of the UV source. FIG. 2A demonstrates that such hydrophilicity can be achieved in less than 10 minutes using UV radiation in an ozone enriched environment.

In addition to the observed rate acceleration, FIG. 2A shows that the water contact angle versus time curve for the combination UV/ozone treatment exhibits an approximately exponential decay profile, whereas FIG. 2B shows that in the prior art technique (i.e. without ozone enrichment), the water contact angle decreases slowly at first and more rapidly later. Accordingly, for applications where only a moderate degree of hydrophilicity is required (e.g. a 60° contact angle), the combination UV/ozone treatment is even more efficient than treatment using radiation alone. In addition, the approximately exponential decay profile is indicative of a relatively simple reaction mechanism, from which can be established a relationship between the surface hydrophilicity and irradiation time. Such a relationship is useful for achieving a controlled level of surface hydrophilicity.

One difficulty associated with the use of surfaces activated using prior art techniques for various applications is the so-called “aging effect”, wherein the hydrophobicity of the activated surface increases (i.e. the surface activation level decreases) during sample storage. Without wishing to be bound by theory, it is believed that reorganization of the polymer chains on surfaces activated using prior art techniques induces the hydrophilic groups to move into the bulk of the substrate.

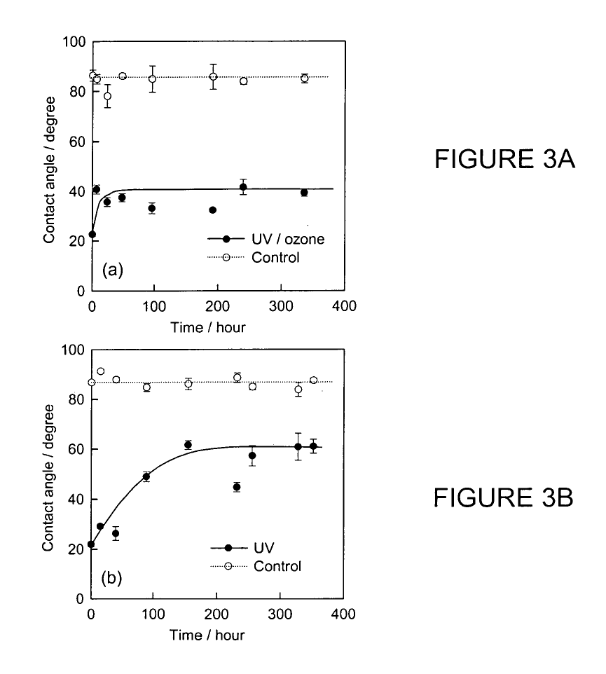

FIGS. 3A and 3B show experimental results for the dependence of water contact angle at a PC surface versus storage time for surface activation methods using UV radiation coupled with ozone reaction (FIG. 3A) and for using UV radiation alone (without ozone) reaction (FIG. 3B). For the particular implementation which gave rise to the date in FIG. 3A, UV radiation was applied for 10 minutes at wavelength(s) of 254 nm and 185 nm at a power of about 15 mW/cm² and ozone was present at a nominal steady state level of approximately 55 ppm. For the data shown in FIG. 3B, UV radiation having an intensity of 6.1 mW/cm² and a wavelength of 254 nm was applied to the PC surface for a period of 15 hours.

As shown in FIGS. 3A and 3B, the aging effects for PC surfaces treated with a UV/ozone combination versus UV alone differ considerably in terms of their time scales and their final contact angles. With surface treatment using a combination of UV/ozone (FIG. 3A), the water contact angle increases initially and then remains constant at approximately 40°. FIG. 3A indicates that the surface activated by the combination of UV/ozone remains relatively active (hydrophilic) even after several days. In contrast, FIG. 3B shows that for the samples activated by UV alone (i.e. without ozone enrichment), the water contact angle shows a relatively gradual increase up to approximately 60°.

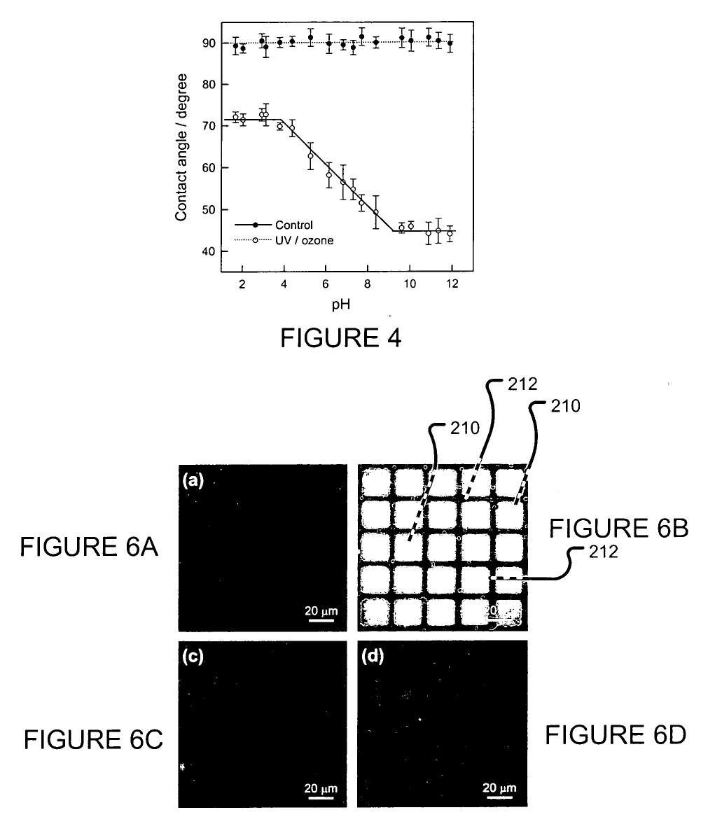

The inventors also performed a number of contact angle titrations to confirm the formation of reactive carboxylic acid (—COOH) groups rather than other polar functionalities (e.g. alcoholic —OH) that tend to reduce the surface hydrophobicity of the PC surface. FIG. 4 shows a typical titration curve (open circles) of contact angles for a PC surface treated with the combination of UV/ozone. For the particular implementation which gave rise to FIG. 4, UV radiation was applied to the PC surface for 10 minutes at wavelength(s) of 254 nm and 185 nm at a power of about 15 mW/cm², ozone was present at a nominal level of 55 ppm and the buffer solutions used for titrations were prepared according to Reference 40 which is hereby incorporated herein by reference (see also below in the section entitled Supplemental Information Relating to Experiments for a description of the buffer solutions).

The FIG. 4 data demonstrates that the contact angles of the buffer solutions went through a relatively smooth transition as their pH was increased from 4 to 9. Without wishing to be bound by theory, the inventors are of the view that this transition is most likely due to the ionization of carboxylic acid groups on the PC surface. The formation of carboxylate anions (—COO⁻) tends to make the surface more hydrophilic. In contrast to the PC surfaces activated with the combination UV/ozone treatment, untreated PC surfaces (solid circles) display a relatively constant contact angle over the entire pH range tested.

The separation of the two “plateaus” in the FIG. 3 curve for the treated PC surface (i.e. at contact angles of about ˜72° and ˜45°) indicate a high surface density of reactive —COOH groups on the PC surface. For a wettability switch of nearly 30° of contact angle, the pH range (from a pH of about ˜4 to a pH of about ˜9) is broader than that observed in the prior art for carboxy-terminated alkyl monolayers on silicon. Without wishing to be bound by theory, this broader pH range may be due to the generation of one or more different types of carboxylic acids upon surface activation (e.g., -φ-COOH and -φ-CH₂COOH). To measure the surface density of the —COOH groups, a cationic dye, crystal violet, was added at a basic pH; this method relies on the electrostatic interactions between crystal violet molecules and carboxylate anions. The average surface density of —COOH was experimentally determined to be (4.8±0.2)×10⁻¹⁰ mol/cm², which is significantly higher than that reported in the prior art (˜2.5×10⁻¹⁰ mol/cm²) for surface activation techniques achieved by one hour UV irradiation alone.

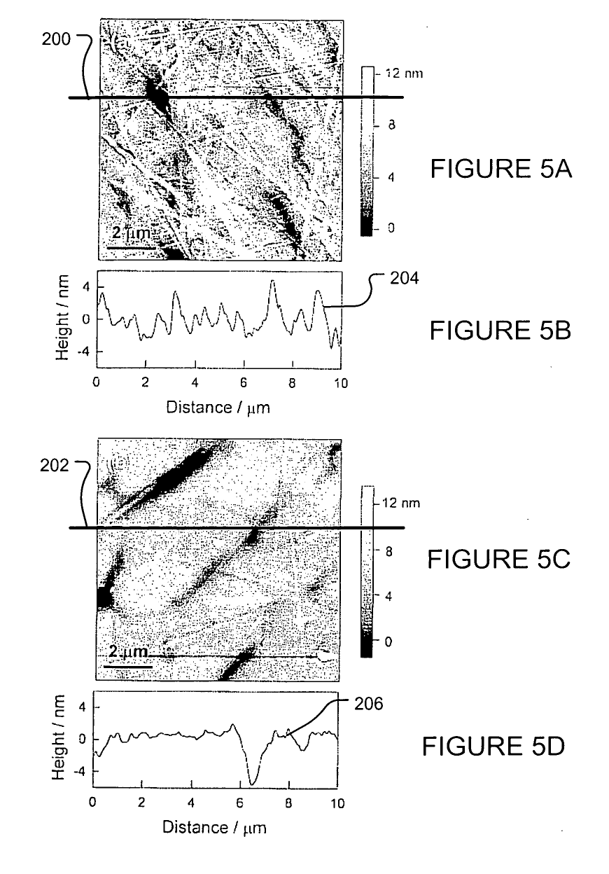

The inventors examined the surfaces of the PC substrates (e.g. optical disc bases) using taping-mode atomic force microscopy (AFM) to determine whether the topography of the PC substrates was significantly altered by the combination UV/ozone treatment. FIGS. 5A and 5C show AFM images of an untreated PC substrate (FIG. 5A) and a PC substrate subjected to a surface activation method involving the combination UV irradiation and ozone (FIG. 5C). FIGS. 5B and 5D respectively depict plots 204, 206 showing AFM height measurements across linear scan lines 200, 202 of FIGS. 5A and 5C. For the particular implementation which gave rise to FIGS. 5C and 5D, the UV radiation was applied for 10 minutes at wavelength(s) of 254 nm and 185 nm at a power of about 15 mW/cm² and ozone was present at a nominal level of 55 ppm. The images of FIGS. 5A and 5C both reveal tracks of polishing on the PC surface caused by the injection molding procedure used for optical disc manufacture. The identical z-axis height scales (˜12 nm) of plots 204, 206 indicate that the combination UV/ozone surface activation treatment did not substantially increase the surface roughness of the PC substrate.

Comparing FIGS. 5C and 5D to FIGS. 5A and 5B, it may also be observed that UV/ozone-treated samples appear relatively smooth and less porous when compared to their untreated counterparts. The RMS roughness factor decreased from 3.0±0.2 nm (for the untreated PC surface of FIGS. 5A and 5B) to 2.2±0.2 nm (for the treated PC surface of FIGS. 5C and 5D). This indicates that the surface activation methods combining UV in the presence of ozone and/or subsequent washing with ethanol/water may remove some material from the PC surface (and thereby increase the surface flatness). Such increased flatness may be beneficial for the preparation of bioassays on PC substrates. The fact that the optical discs (PC substrates) were not physically damaged and remained readable after the surface activation (UV/ozone) procedure appears to indicate the potential application of the combination UV/ozone activation process for the fabrication of optical disc-based biochip devices that are readable in standard optical drives. In some embodiments, the intensity of the UV radiation used to irradiate the surface is sufficiently low such that a root mean square (RMS) surface roughness of the surface after irradiating the surface with UV radiation is less than twice the RMS surface roughness of the surface prior to irradiating the surface with UV radiation.

The combination UV/ozone surface activation processes described herein are substantially faster (short reaction time), more effective (the activated surface is more hydrophilic and the hydrophilicity lasts for a longer period of time), and non-destructive when compared to previous UV-irradiation-only activation methods.

Photo-Patterning and Passive DNA Immobilization/Hybridization.

Upon generation of reactive carboxylic acid groups in accordance with the activation processes described herein, the optical disc surface is converted into an effective platform for the construction of biochips. The inventors have demonstrated this application by the immobilization of DNA probe strands on the activated PC surface and subsequent hybridization with target samples using incubation techniques (e.g. by immersion of the activated PC substrates in bulk samples of modified DNA strands for coupling and hybridization). Other biological macromolecules (such as, by way of non-limiting example, protein, antibodies/antigens and carbohydrates) could be immobilized in a similar manner for various bioassay applications.

In one particular implementation for which experimental data was obtained, a PC base was first treated with a combination UV/ozone activation wherein the UV radiation was applied for 10 minutes at wavelength(s) of 254 nm and 185 nm at a power of about 15 mW/cm² and ozone was present at a nominal level of 55 ppm. The UV radiation was applied to the PC surface through transmittance electron microscopy (TEM) grids, which were used as photomasks over the PC surface to achieve surface activation and micro-patterning of the PC surface in a single step. DNA probe strands were then attached to the activated and micro-patterned PC surface. To attach specific DNA probe strands (listed in Table 1) modified at their 5′-ends with amino groups via C6 linkers, amide linkages were formed via a 1-ethyl-3-(3′-dimethylaminopropyl)-carbodiimide (EDC)/N-hydroxysuccinimide (NHS) coupling reaction, as described in Reference 46 which is hereby incorporated herein by reference.

TABLE 1

Oligonucleotide sequences of the probe and
target DNA samples.

| | |
|---|---|
| DNA strand | Sequence |

| | |
|---|---|
| Probe I | 5′-Amino-C6-CGC CGA TTG GAC AAA ACT TAA A-3′ |
| Probe II | 5′-Amino-C6-CGC CGA TTG GA [symbol] AAA ACT TAA A-3′ |
| Probe III | 5′-Amino-C6-TTT AAG TTT TGT CCA ACT GGC G-3′ |
| Target I | 3′-GCG GCT AAC CTG TTT TGA ATT T-5′-fluorescein |
| Target II | 3′-GCG GCT AAC CTG TTT TGA ATT T-5′-Cy5 |
| Marker | 5′-Amino-C6-CGC CGA TTG GAC AAA ACT TAA A-3′-Cy5 |

FIG. 6A depicts a fluorescence image of a PC surfaces after surface activation with the combination UV/ozone treatment described above using a TEM grid as a photomask. FIG. 6B depicts the same PC surface after hybridization of complementary DNA probe strands (Probe I) with fluorescein-labeled DNA targets (Target I).

In contrast to FIG. 6A, FIG. 6B shows that, upon hybridization of the immobilized complementary DNA probe strands (Probe I) with fluorescein-labeled DNA targets (Target I), distinct patterns are observable using fluorescence microscopy. Areas 210 exposed to the above-discussed UV/ozone surface activation through the TEM mask fluoresced brightly, while unexposed areas 212 (blocked by the TEM grid) did not produce significant fluorescence. FIG. 6B demonstrates that relatively few (if any) DNA strands were covalently immobilized at the relatively dark locations 212 where the UV/ozone treatment was blocked by the TEM grid. FIG. 6B also shows that non-specific adsorption of DNA target strands to the PC surface under passive adsorption conditions is negligible.

As an experimental control, single-base mismatched and non-complementary amino-terminated DNA probes were tested using the same procedure. FIGS. 6C and 6D show the results of this control for the hybridization of fluorescein-labeled target DNA with non-complementary target and probe DNA strands (FIG. 6C—Probe III and Target I) and for the hybridization of fluorescein-labeled target DNA with probe strands containing a single-base mismatch (FIG. 6D—Probe II and Target I). FIG. 6D shows that the fluorescence images for the single-base mismatch target and probe DNA strands (Probe II and Target I) exhibit low-intensity fluorescence while FIG. 6C shows that no obvious patterns were discernible in the fluorescence images for the non-complementary target and probe DNA strands (Probe III and Target I). The differences between FIGS. 6B, 6C and 6D demonstrate the high selectivity of the hybridization reactions on the activated PC surface.

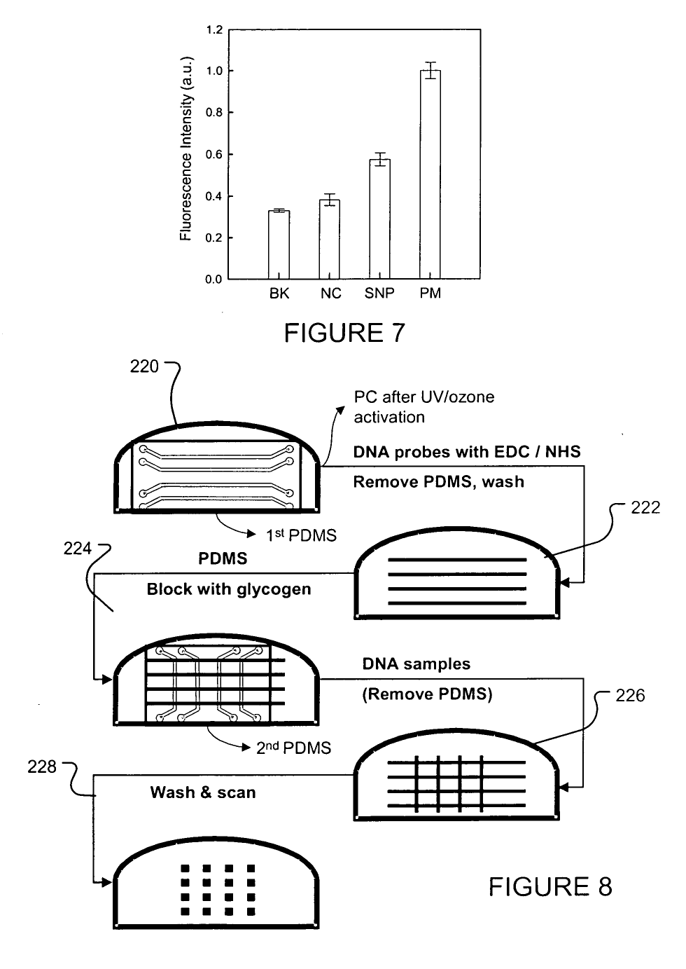

FIG. 7 is a bar graph showing the relative fluorescence intensities of the PC surfaces in FIGS. 6A-6D. More particularly: bar BK represents the fluorescence intensity prior to DNA hybridization (FIG. 6A); bar PM represents the fluorescence intensity corresponding to hybridization of DNA probe strands with complementary fluorescein-labeled DNA targets (FIG. 6B); bar NC represents the fluorescence intensity corresponding to non-complimentary probe and target strands (FIG. 6C); and bar SNP represents the fluorescence intensity corresponding to single-base mismatch probe and target DNA strands (FIG. 6D).

FIG. 7 shows that the relative fluorescence intensity of the single-base mismatch samples (SNP) was less than 60% of that of the matched samples (PM). FIG. 7 also shows that hybridization of non-complementary strands (NC) increased the fluorescence signal intensity only slightly (5%) relative to the background (BK) having no hybridization. The hybridization sensitivity (i.e. the ability to hybridize complementary probe and target strands) and hybridization selectivity (i.e. the ability to discriminate between complementary strands and strands with mismatched bases) for the amide-coupling chemistry and the fluorescence detection of DNA hybridization achieved using UV/ozone-activated PC surfaces is significantly greater than that available using prior art PC surface activation processes.

Microfluidic DNA Microarrays on PC. The inventors used microfluidic methods to create DNA microarrays on PC surfaces activated using the combination UV/ozone surface activation technique to demonstrate the application of the UV/ozone surface activation technique for the activation of plastic materials in biochip fabrication. Microfluidic methods for creating DNA microarrays on surfaces are described in References 26, 27, 32 and 48, which are hereby incorporated herein by reference. In comparison with traditional DNA microarray fabrication procedures (either by on-chip photolithographic synthesis of DNA probes or by robotic spotting of pre-synthesized oligonucleotides, for example), microfluidic methods for creating DNA microarrays are simple and do not require expensive facilities or instrumentation.

FIG. 8 schematically depicts a microfluidic method for creating DNA microarrays on PC surfaces activated using a combination UV/ozone treatment in accordance with a particular embodiment of the invention. After activation of a PC substrate using the above-described UV/ozone surface activation method, a PDMS (polydimethylsiloxane) microchip is mounted on the activated PC substrate for immobilization of probe strands (i.e. to form a line array) as shown at 220. DNA probe strands are then applied to the surface in the presence of 1-ethyl-3-(3′-dimethylaminopropyl)carbodiimide (EDC) and NHS (N-hydroxysuccinimide (NHS). The EDC and NHS help to enable the coupling between the amine-terminated DNA probes and the carboxylic acid groups on the activated PC surface. The PDMS chip is then removed and the surface is washed as shown at 222. The PC surface is then treated with glycogen to block the unreacted acid groups (this helps to minimize non-specific adsorption of target DNA strands). Target samples may then be delivered in a line array formation using a second PDMS plate as shown at 224. The target sample line array may be oriented so as to intersect the probe line array as shown at 224. As shown at 226, hybridization occurs at the intersection of the target sample microchannels formed using the second PDMS microchip and the previously formed probe line array. After removing the second PDMS microchip, washing and scanning the PC surface, the array pattern shown at 228 is formed. For the particular implementation for which experimental data is available, the oligonucleotide sequences for the probe and target DNA strands are shown in Table 1.

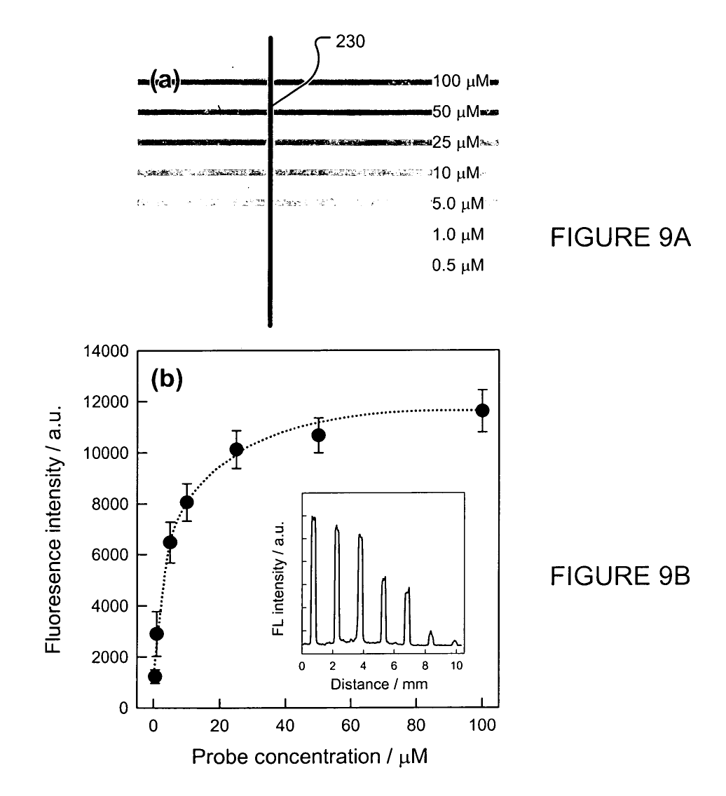

In order to examine the efficiency of flow-through immobilization of DNA probes on PC substrates, the inventors used different concentrations of a marker strand modified with an amino group at the 5′-end for surface coupling and with a fluorescent tag (Cy5) at the 3′-end for imaging (see Table 1). The results of this examination are shown in FIGS. 9A and 9B. As shown in FIG. 9A, a DNA line array was formed on a UV/ozone activated PC surface using 0.5 μl samples having different levels of concentration as low as 0.5 μM and as high as 100 μM. The saturation surface density of marker strands is reached at a concentration of approximately 25 μM. As shown in FIG. 9B, concentrations above 25 μM do not lead to significant increases in contrast of the fluorescence image. Consistently, the surface density of the immobilized marker strand determined by radioisotope labeling exhibited a similar trend as that of fluorescence measurements. The surface density of DNA strands does not exhibit significant increases for concentrations of marker solution greater than about 25 μM. The surface density of DNA probes fabricated on the UV/ozone activated PC surface was determined to be 5.4±0.3 pmol/cm² via radioactivity measurements. This surface density is smaller, but of the same order of magnitude, as value of 10 pmol/cm² reported in the prior art for activated polymethylmethacrylate (PMMA). It should be noted that in this microfluidic format, the consumption of DNA sample is very little (about 0.5-25 pmol), considerably less than the DNA sample consumption associated with the passive immobilization method.

While not wishing to be bound by any particular theory, the rate of surface coupling (i.e. of DNA to the activated PC surface) may be limited by the diffusion of DNA molecules to the surface; this appears to be the primary reason for the more efficient immobilization in the flow-through setting. A larger amount of DNA molecules can be transported to the PC surface by convection (flow) than by passive incubation. This interpretation is supported by the depletion effect, i.e., the apparent “fading” of the probe line at low marker concentrations (FIG. 9A).

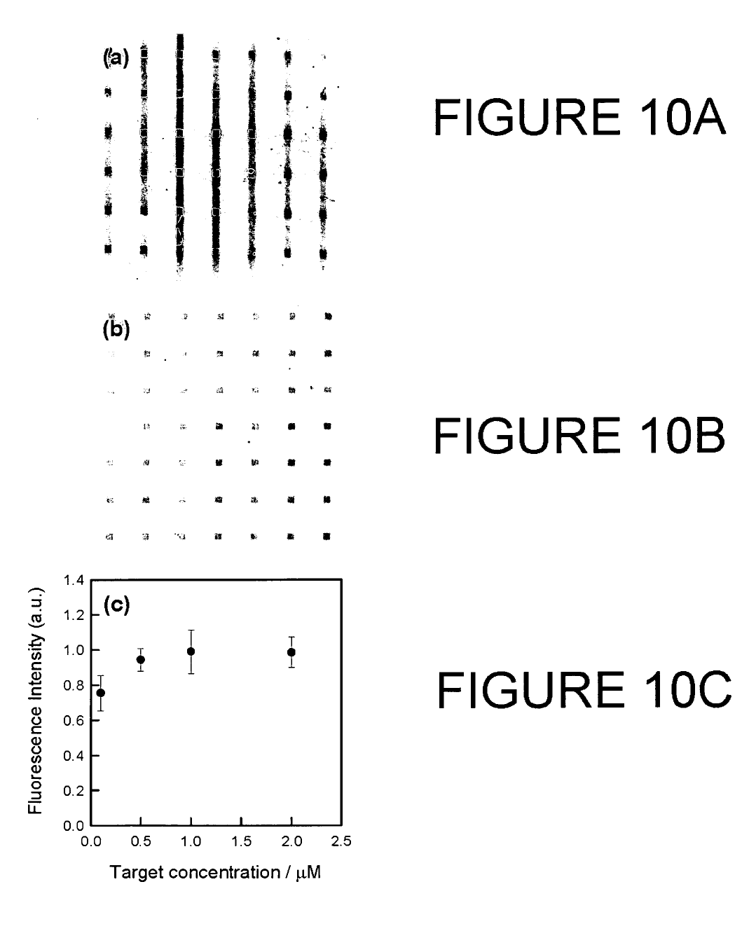

The efficient immobilization of single-stranded DNA (ssDNA) probes led the inventors to test the hybridization with specific DNA targets using the microfluidic technique, assuming that non-specific adsorption of DNA strands can be minimized. FIGS. 10A and 10B show fluorescence images of the hybridizations of complementary probe strands (Probe I) and target strands (Target II at 1.0 μM) at 40° C. for 30 min using different hybridization buffer solutions: Tris buffer solution (pH=7.4, 10 mM Tris+500 mM NaCl+50 mM MgCl₂)—FIG. 10A; and 1×SSC (Saline-Sodium Citrate) buffer (pH=7.0, 150 mM NaCl+15 mM sodium citrate) with 0.15% sodium dodecylsulfonate (SDS) added —FIG. 10B.

As shown in FIGS. 10A and 10B, all hybridization sites (at the intersections of the line arrays) in the two images have uniform shape and high fluorescence intensity, indicating the on-chip hybridization between complementary probe strands (Probe I) and target strands (Target II) is efficient. However, for the Tris buffer solution used in FIG. 10A, the non-specific adsorption of DNA target strands on the activated PC substrate is discernable, as illustrated by the “trails” left behind target flow lines (i.e. the vertically oriented lines in FIG. 10A). These “trails” also indicate that not all the surface carboxylic acid groups have reacted with probe DNA strands. As shown in FIG. 10B, the inventors have discovered that such non-specific adsorption can be effectively reduced by changing the hybridization buffer from Tris to SSC (with 0.15% SDS added). SDS effectively blocks the non-specific adsorption of DNA strands by the activated PC substrate. As shown in FIG. 10B, use of SSC (with 0.15% SDS added) as a buffer solution, provides hybridization sites which are clearly distinct from the background (i.e. no discernible “trails” behind the target flow line) and which exhibit overall uniformity (i.e. in the shape, size, and fluorescent intensity of each hybridization site).

Using immobilization and hybridization experiments, the inventors have determined that the overall uniformity of hybridization spots can be easily repeated from one chip to another. The thermal and chemical stability of immobilized DNA probes created on the PC substrates have been examined by varying the temperature (up to 90° C.) and salt concentrations (up to 0.1 M). Such high temperatures and high salt concentrations did not result in significant changes (i.e., about 2% variation after each cycle) in the hybridization capabilities.

In addition to the choice of buffer solution, the inventors also systematically investigated the effect of target concentration on the hybridization results (e.g. the lowest concentration that produces detectable signal that is measurably different than the background noise (for example, three times greater than the background noise is a current industry standard))−also referred to as the detection limit). FIG. 10C shows the relative intensity of fluorescence as a function of target concentration for the hybridizations of complementary probe strands (Probe I) and target strands (Target II at 1.0 μM) at 40° C. for 30 min using the SSC (with 0.15% SDS) buffer solution of FIG. 10B. As shown in FIG. 10C, the hybridization signal (i.e. the fluorescence) initially increases for corresponding increases in target strand concentration, but then reaches a plateau at a target strand concentration of approximately 0.5 μM. FIG. 10C also shows that even at the very low target strand concentration of 0.1 μM (0.5 μl×0.1 μM=0.05 pmol), a clear hybridization signal can be observed. The on-surface hybridization efficiency (i.e. the ratio of the amount of on-surface hybridized target to that of probe strands) determined by radioisotope labeling was about 5.6% (corresponding to a target surface density of about 0.30±0.01 pmol/cm²), which is close to the value (7.5%) reported in the prior art for PMMA surfaces.

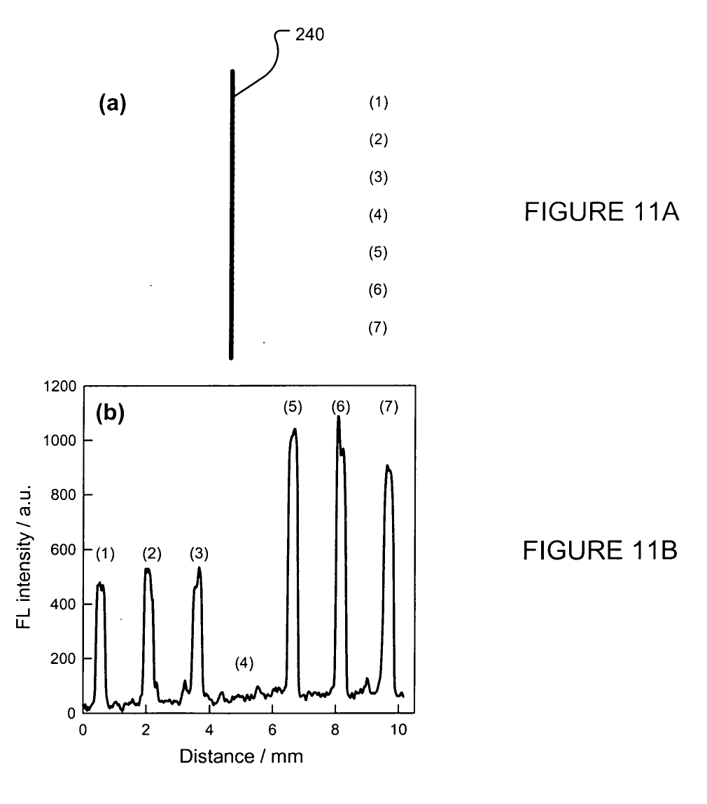

Based on the effective probe immobilization and on-surface target hybridization, the inventors performed a DNA identification assay to evaluate the hybridization of the same DNA target strand with three different probe strands that were immobilized with the first PDMS channel plate. The results of this experiment are shown in FIGS. 11A and 11B. Lines 1-3 of FIG. 11A represent single-base pair mismatched amine-modified DNA probes; line 4 of FIG. 11A represents non-complementary amine-modified DNA probes; and lines 5-7 of FIG. 11A represent complementary probes. With the exception of these differences, all of the lines shown in FIG. 11A were tested using the same procedure—i.e. delivery of the same target sample (1 μM) using microfluidic channels on a preformed DNA probe (50 μM) line array at 40° C. for 5 minutes. FIG. 11B depicts fluorescence intensity versus distance along the projection shown as line 240 in FIG. 11A. The FIG. 11B peaks are labeled according to the line numbers shown in FIG. 11A.

Before hybridization, fluorescence was not detected on the chip (data not shown). As shown in FIGS. 11A and 11B, the hybridization of Cy5-labeled target DNA (Target II) with probe strands containing a single-base mismatch (Probe II) resulted in relatively low-intensity fluorescence signals at their intersections with lines 1-3. In comparison, there was no discernable increase in fluorescence when the target and probe DNA strands (Probe III) were non-complementary (i.e. at the intersections with line 4) and the fluorescence intensities at the intersections of target sample with the complementary probe (Probe I) in lines 5-7 were relatively high. The inventors have also confirmed that the discrimination ratio (e.g. a quantitative measure of the difference between the signal associated with complementary probe and target strands versus the signal associated with probe and target strands having a single-base pair mismatch) is sensitive to the assay conditions such as time and temperature. In addition, the hybridization spots shown in the conditions giving rise to FIGS. 11A and 11B were clearly distinct from the background (i.e. no “trails”), again confirming that the above-described techniques are not susceptible to non-specific adsorption of DNA strands.

Although the experimental conditions can be further optimized to achieve higher sensitivity, the above-described results demonstrate the feasibility of creating DNA hybridization microarrays on PC substrates after surface activation by a combination of UV irradiation and ozone reaction and illustrate how the inventors' surface activation methods can be applied to the preparation of bioreactive substrates for the fabrication of microanalytical devices.

### Supplemental Information Relating to Experiments

The following section describes particular non-limiting techniques, supplies and equipment used by the inventors to carry out the specific experiments described above.

Surface Activation and Characterization. In the experiments described above, polycarbonate (PC) bases of optical discs were provided by Millennium Compact Disc Industries Inc. (Vancouver, BC, Canada), or prepared from regular optical discs by: removing the reflective layer via scoring and vigorous rinsing with deionized water; removing the dye layer with a rapid methanol rinse, 10-min ultrasonication in 1:4 (v/v) methanol/water; and providing a final rinse with deionized water (see Reference 20 which is hereby incorporated herein by reference). The DNA oligomers (sequences listed in Table 1) were of reverse-phase cartridge purification (RP1) grade and obtained from Sigma-Genosys (Oakville, ON, Canada).

The PC surfaces were activated using the combination of UV radiation and ozone reaction as discussed above using a UV irradiating system (Model PSD-UV) from Novascan Technologies, Inc. (Ames, Iowa, USA). This apparatus uses a low-pressure mercury lamp and generates UV emission at two wavelengths (185 nm (1.5 mW/cm²) and 254 nm (13.2 mW/cm²) with a total power of about 15 mW/cm².

Water contact angles on activated PC surfaces were measured with an AST Optima system at ambient conditions (22-26° C., 43±3% relative humidity) using a horizontal light beam to illuminate the liquid droplet. The contact angles described above are the values of sessile liquid drops of either pure water or aqueous buffer solution. The surface topographies of the pristine and the UV/ozone-treated PC surfaces were examined with an MFP-3D-SA Atomic Force Microscope from Asylum Research, Inc. (Santa Barbara, Calif., USA) in tapping mode. Root-mean-square (RMS) roughness factors were calculated using the IGOR Pro 4 software provided by the manufacturer.

Photo-patterning and Passive DNA Immobilization/Hybridization. After the activation process using combined UV radiation and ozone reaction, 10 μl of a 10 μM solution of DNA probe strands in 0.1 M MES (2-(N-morpholino) ethanesulfonic acid) buffer at pH 6.5 (also containing 5 mM EDC (1-ethyl-3-(3′-dimethylaminopropyl)carbodiimide) and 0.33 mM NHS (N-hydroxysuccinimide)) were spread onto the patterned PC surface (a TEM grid was placed on top during UV/ozone treatment). The sample was incubated for 2 hours under ambient conditions. For the hybridization test, a 10 μM solution (10 μl) of fluorescein-labeled DNA target strands (0.1 M MgCl₂ and 1 M NaCl in 10 mM Tris-HCl buffer) was spread onto the surface. After immobilization, DNA oligomers immobilized on the PC base of the optical disc were imaged with a Zeiss LSM 410 confocal microscope (Oberkochen, Germany) equipped with krypton/argon laser sources. Creation of Microfluidic DNA Microarrays on PC. The PDMS microchannel plates were prepared following the standard procedure reported in the literature (see Reference 52 which is hereby incorporated herein by reference). The first channel plate (with 8 to 12 channels) was sealed with the activated PC for DNA probe immobilization. Probe DNA samples (typically 0.5 μl were injected into the channel reservoirs on one side and passed through the channels by suction from the other ends of the channels. The solution was allowed to stay in the channel for 5-10 hours at room temperature for DNA probe immobilization. To wash, Tris buffer was passed through the channels at least three times. Then the PDMS plate was peeled off, and the substrate was treated with glycogen solution to reduce (potential) nonspecific adsorption. Afterward, the second PDMS chip was placed on top of the substrate but in a substantially perpendicular orientation. Hybridization was done by using Cy5-labeled DNA strands (0.1-2 μM); this step took place in a humid box at 20-40° C. for 30 min. After hybridization, the PDMS plate was peeled off, and the PC surface was washed with buffers and dried with nitrogen gas. The PC surface was then scanned using a Typhoon 9410 confocal laser-fluorescence scanner available from Amersham Biosystems (now GE Healthcare) at a resolution of 25 μm. Radioisotope labeling measurements. 50 pmol 5′-modified ssDNA and 100 pmol DNA template with a two-nucleotide-5′ overhang (3′-TG-5′) were hybridized in 5 μl buffer (50 mM Tris at pH 7.2, 10 mM MgCl₂, 0.1 mM DTT, 1 mg/ml BSA) by heating at 90° C. for 2 min, followed by immediate cooling with ice. The labeling reaction was started by adding 5 μl of the above buffer, containing 1 nmol dATP, 6.67 pmol [α-³²P]dATP (3000 Ci/mmol, 10 mCi/ml) and 2 U Klenow fragment of DNA polymerase I (Roch, Mannheim, Germany). After 2 hours, the labeled oligonucleotides were purified by precipitation with ethanol followed by 20% denaturing polyacrylamide gel electrophoresis (PAGE). The procedure for the modification and washing of the PC surface with ³²P-radiolabeled DNA was the same as other DNA strands (without radiolabeling). The DNA surface density was calculated by comparing the radioactivity of DNA immobilized on a certain area of the PC surface with that of a known amount of DNA. For this purpose, two control samples having known amount of ³²P-radiolabeled DNA were dropped on two reference PC surfaces and allowed to air-dry without any washing. The radioactivity was read by phosphor imaging using the Typhoon 9410 scanner.

Thermal/chemical stability tests. PC substrates with immobilized DNA probes were treated under PCR (Polymerase chain reaction)-like conditions (alternate immersions of the chip into three buffers at different temperatures) for up to 10 cycles. Each cycle consisted of a “denaturing step” at 90° C. for 30 s, an “annealing step” at 50° C. for 30 S and an “extension step” at 72° C. for 30 s. After each cycle of the treatment, the slides were washed and used for hybridization experiments as described above.

### Further Supplemental Information Relating to Experiments

The following section provides additional, non-limiting information relevant to particular experiments conducted by the inventors.

Reagents and materials. 1-Ethyl-3-(3′-dimethylaminopropyl)carbodiimide (EDC, water-soluble carbodiimide), N-hydroxysuccinimide (NHS) and glycogen (Type III, from rabbit liver) were purchased from Sigma-Aldrich (St. Louis, Mo.), 2-(N-morpholino)ethanesulfonic acid (MES) from Fluka (Buchs, CH), sodium chloride, tris(hydroxymethyl)aminomethane, sodium citrate, sodium dodecylsulfonate (SDS), and magnesium chloride from Calcdon Laboratories Ltd (Georgetown, ON). All chemicals used without further purification unless otherwise stated. All solutions were prepared with deionized water (>18.3 MΩ·cm) from a Barnstead EasyPure UV/UF compact water system (Dubuque, Iowa). The 22-mer synthetic oligonucleotides used as probe/target strands in the experiments were of reverse-phase cartridge purification (RP1) grade and obtained from Sigma-Genosys (Oakville, ON).

Polycarbonate (PC) bases of compact discs (CDs) were provided by Millennium Compact Disc Industries Inc. (Vancouver, BC). They can also be prepared from regular CDs (or CD-Rs or the like) by removing the reflective layer via scoring and vigorous rinsing with deionized water, removal of the dye layer with a rapid methanol rinse, 10 min ultrasonication in a 1:4 (v/v) methanol/water solution and a final rinse with deionized water (see Reference 20). Transmittance electron microscopy (TEM) gold grids (G1000HSG, Pelco International) were used as masks for patterning the PC surfaces. They were made of 6-μm-diameter wires with a center-to-center spacing of 25 μm.

Activation and patterning of the PC substrates by UV/ozone treatment. Without wishing to be bound by any particular theory, it is thought that the photochemistry of polycarbonate exposed to UV light involves two photo-Fries reactions, a photo-induced oxidation of the side-chain and a benzene ring oxidation. The reaction pathway followed is thought to depend primarily on the excitation light source and the oxygen concentration. The main photochemical process occurring under irradiation at 254 nm in the presence of oxygen may be the succession of two photo-Fries rearrangements leading to the formation of phenyl salicylate and dihydroxybenzophenone units. Competitively, some radicals may react with oxygen to form hydroperoxides. Eventually the photo-oxidation leads to the formation of carboxylic acid groups. Particular theories as to the photochemistry of PC exposed to UV light are described in References 35, 42, 54 and 55.

The UV/ozone treatment of the PC surface was carried out with a UV/ozone system (Model PSD-UV, Novascan Technologies, Inc.). This apparatus uses a low-pressure mercury lamp, generating ultraviolet emission at both 185 nm and 254 nm with a total power measured to be about 15 mW/cm²; the distance between the UV source and the PC sheet was 2.5 cm. In the presence of ambient oxygen, the two-step photochemical process initiated by the photolysis of molecular oxygen (O₂) at 185 nm produces a nominal steady-state concentration of highly reactive ozone which then decomposes by absorption of UV light at 254 nm.

Contact angle measurements of UV/ozone-treated PC surface. Contact angle measurement is one convenient technique for characterization of solid/liquid interfaces. Water contact angles on activated PC surfaces were measured with an AST Optima system at ambient conditions (22-26° C., 43±3% relative humidity) using a horizontal light beam to illuminate the liquid droplet. The contact angles described above are equilibrated values of sessile liquid drops of either pure water or buffer solution.

The untreated PC substrate is hydrophobic with a water contact angle of 88±2°. During UV/ozone treatment, the surface became more and more hydrophilic (see FIG. 1) with increasing irradiation time. After 10 min, the angle remained constant at 20÷2°. In contrast, the water contact angles decreased to a similar value after at least 15 hours when the PC substrates were treated by irradiation alone with UV radiation of 6.1 mW/cm² at 254 nm (Photoreactor LZC-4V, Luzchem Research, Inc.). The same trend was observed when the PC substrates were micro-patterned with TEM grids as masks during the UV/ozone treatment.

For the contact angle titration (see FIG. 3), the activated PC samples were immersed in the buffer solution for 30 s before the contact angle was measured. The buffer solutions were prepared as follows: pH 0-1, perchloric acid; pH 2-3, phosphoric acid/sodium phosphate monobasic; pH 4-5, acetic acid/sodium acetate; pH 6-8, sodium phosphate monobasic/sodium phosphate dibasic; pH 9-11, sodium bicarbonate/sodium carbonate; pH 12, sodium phosphate dibasic/sodium phosphate tribasic. In all cases, the ionic strength was kept constant (0.01 M). The pH values for the buffer solutions were recorded before and after the contact angle measurements. The contact angle transition between pH 4 and 9 corresponds to the ionization of surface carboxylic acid groups. As these groups are transformed to carboxylate groups upon exposure to a basic aqueous buffer solution, the surface becomes more hydrophilic: the free energy of the solid/liquid interface becomes lower and the contact angle decreases. The process of surface ionization is fully reversible as indicated by reproducible contact angle measurements.

Determination of the surface density of carboxylic acid groups on activated PC. To determine the surface density of carboxylic acid groups (COOH) groups resulting from UV/ozone treatment, a cationic dye, crystal violet, was used. This method makes use of the electrostatic interactions between crystal violet molecules and carboxylate groups. First, the UV/ozone-irradiated substrates were covered with a crystal violet solution (1 mM) for 5 min. After rinsing with water, the samples were incubated first with ethanol (80% v/v) and second with 0.10 M HCl (in 20% ethanol) until the dye could no longer be observed on the sample surface. Then the solutions from the two incubations were combined and absorbance readings were taken with a UV/Vis spectrometer. The concentration of crystal violet released from the surface was calculated from Beer's law (A=εcl) and used to determine the surface density of COOH groups. The reported value of 4.8±0.2×10⁻¹⁰ mol/cm² represents an average over three samples.

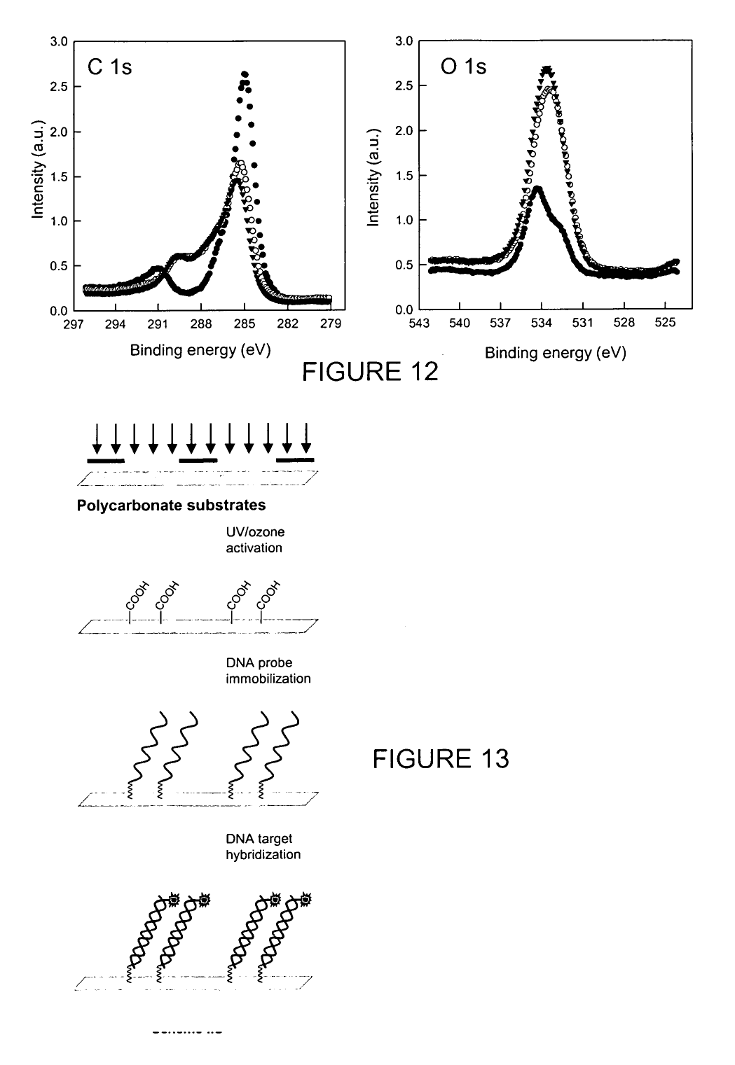

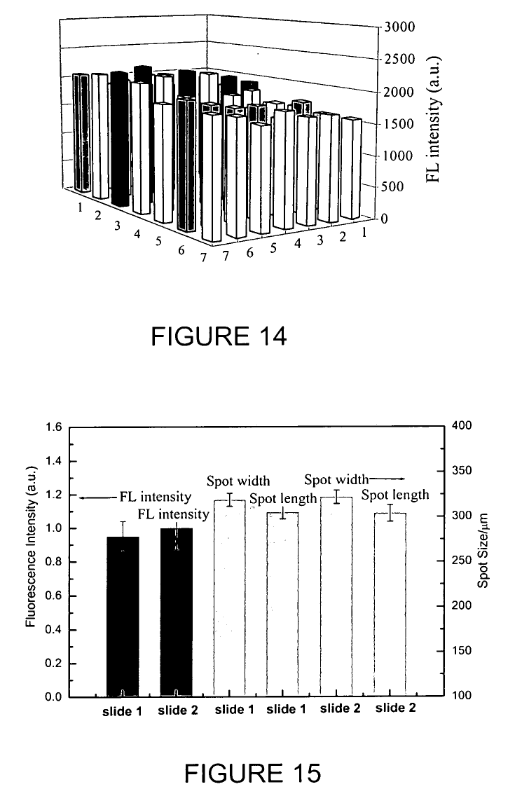

XPS confirmation of the carboxylic acid groups generated on PC upon UV/ozone treatment. The generation of reactive carboxylic acid groups was further confirmed by x-ray photoelectron spectroscopic (XPS) studies of three types of PC samples: original, UV/ozone-treated, and UV/ozone-irradiated through a TEM grid. The characteristic C 1s and O 1s signals are shown in FIG. 12. The C 1s spectrum of untreated substrate consists of two main components with binding energies of 284.6 eV and 291.0 eV, respectively. Without wishing to be bound by any theory, these components may arise from the aryl or alkyl carbons, and from the carbonate units (—OCOO—) and the appearance of a distinct shoulder peak at high binding energy (288.6 eV) on sample exposure to UV/ozone may indicate the generation of carboxylic acid groups (—COOH). The patterned surface showed less significant changes upon UV/ozone treatment, and the intensity of the C 1s signal at 284.6 eV decreased gradually. The 0 is peak of the untreated PC substrate showed both O═C and O—C components with binding energies of 532.3 and 534.0 eV, respectively, whereas irradiated substrates exhibited a broad peak centered at 533.0 eV, which may be resulting from the new species.

Comparison of the surface activation efficiency by different UV irradiation methods. As shown in Table 2, the surface density of active groups (and the surface wettability) on polymeric materials upon UV treatment depends on various irradiation conditions (such as wavelength, powder, and duration). Compared with other UV irradiation methods, the UV/ozone methods described herein show higher surface activation efficiency (i.e. shorter reaction time and higher —COOH surface density), especially for PC substrates.

TABLE 2
Comparison of surface activation efficiencies of different UV
irradiation methods

| | UV irradiation condition | Surface wettability | Active groups surface | |
|---|---|---|---|---|
| | (wavelength, power and | (before/after) and | density/ | |
| Substrate | distance from the light | the irradiation | 10⁻¹⁰mol · cm² | |
| material | source) | duration | and time dependence | Ref |
| PMMA | 240~425 nm, 15 mW · cm⁻² | 70° / 24° (30 min) | Γ_{COOH} = 13.12± 0.93 (30 | 13 |
| | (maximum), d = 1 cm | | min) | |
| PMMA | 254 nm, 15 mW · cm⁻², d = 1 | | Γ_{DNA probe} = 0.41 (PMMA, | 14 |
| | cm | | 15 min) | |
| PMMA, | 254 nm, 15 mW · cm⁻², d = 1 | 70° / 52° (PMMA, 2 | Γ_{COOH} = 10 (PMMA, 20 | 15 |
| PC | cm | h) | min) | |
| | | 83° / 50° (PC, 2 h) | 1.0 (PC, 20 min) | |
| PS, PC | 185 nm, 15 W, d = 10 cm | | Γ_{peroxide} = 20 (PS, 20 min) | 16 |
| | | | 5.0 (PC, 20 min) | |
| PMMA | *Vacuum Ultraviolet | 80° / 30° (10³ Pa, 30 | | 17 |
| | 172 nm, 10 mW · cm⁻², d = 2 | min) | | |
| | cm | | | |
| PC | 220 nm, 4W | 70° / 20° (6.5 h) | | 18 |
| PC | 185 nm + 254 nm (15 | 88° / 20° (10 min) | Γ_{COOH} = 4.8 ± 0.2 (10 | This |
| | mW · cm⁻²⁾ + ozone, d = 2.5 | | min) | work |
| | cm | | Γ_{DNA probe} = 0.054 ± 0.003 | |

PMMA (polymethylmethacrylate), PS (polystyrene), PC (polycarbonate)

Photo-patterning of PC and passive DNA immobilization/hybridization. FIG. 13 shows a particular embodiment of a technique for DNA immobilization/hybridization which involves: surface activation/patterning, attachment of DNA probe strands, and hybridization/detection of the target strands. CD bases may cut into small pieces (2×4 cm²), placed into the UV/ozone chamber and irradiated for 10 min through a TEM grid. Upon completion of this UV/ozone surface activation treatment, the PC surface may be left in the ozone environment for 25 min. After the activation step, 10 μL of a 10 μM solution of DNA probe strands in 0.1 M MES buffer at pH 6.5 (also containing 5 mM EDC and 0.33 mM NHS) may be spread onto the patterned PC surface, and the sample may be incubated for 2 hours under ambient conditions. The PC substrate modified with DNA probe strands may then be washed with 0.01 M MES buffer and blow-dried with N₂ gas. To passivate unreacted carboxylic acid groups, the surface may be washed with a dilute solution of glycogen (1 mg/mL) prior to hybridization. A 10 μM solution (10 μL) of fluorescein-labeled DNA target strands (0.1 M MgCl₂ and 1 M NaCl in 10 mM Tris-HCl buffer) may then be spread onto the surface. Hybridization may be facilitated by heating to 90° C., then cooling slowly to room temperature.

For the particular experiments described herein, after hybridization the PC chips were imaged on a Zeiss LSM 410 (Oberkochen, Germany) confocal microscope equipped with a ×25 (NA 0.8) multi-immersion objective. An argon/krypton mixed gas laser with excitation lines at 488, 568, and 647 nm was used to induce fluorescence. Excitation of the green fluorophore was achieved at 488 nm (the effective excitation range of 488-495 nm for fluorescein closely matches the photo-emission of an argon laser), and the resulting fluorescence was observed by using a 515-540 nm band pass filter.

Creation of DNA microarrays with microfluidic channel plates. A small PDMS plate with 8 to 12 microchannels (300 μm wide and 25 μm deep) was laid on top of an activated PC substrate. The probe solution (0.5 μL) containing 5′-amine-modified DNA molecules (10-50 μM in phosphate buffer, 0.10 M, pH 7.0) was injected into the reservoir on one terminal of a microchannel and passed through the channel by suction from the other end. After 10 hours incubation in a humid box at room temperature, the channel was washed with the phosphate buffer.

The PDMS plate was then peeled off from the PC substrate. The surface was “blocked” with glycogen and washed again with the phosphate buffer. Another PDMS plate was then laid on top of the PC surface, but in a substantially perpendicular orientation with respect the first plate. Hybridization with Cy5-labeled DNA samples (1-2 μM) in pH 7.4 buffer (10 mM Tris, 500 mM NaCl, 50 mM MgCl₂) or in ×1 SSC pH 7.0 buffer (15 mM Na₂C₂O₄, 150 mM NaCl, 0.15% SDS) was carried out at 20-40° C. for 30-60 min.

After hybridization, the microchip was washed sequentially with three buffers (pH 7.4): Tris (10 mM)+NaCl (50 mM), Tris (10 mM)+NaCl (10 mM), and Tris (10 mM) only. If a SSC buffer was used in the hybridization experiment, it was also used to wash the microchip twice. Afterwards, the PC chip was rinsed with water and dried with nitrogen gas. A confocal laser-fluorescent scanner (Typhoon 9410, Amersham Biosystems) at a resolution of 25 μm was used to examine the efficiency of marker strand immobilization and of the hybridization.

### ADDITIONAL AND ALTERNATIVE EMBODIMENTS

As will be apparent to those skilled in the art in the light of the foregoing disclosure, many alterations and modifications are possible in the practice of this invention without departing from the spirit or scope thereof. For example:
The description set out above describes a PC substrate formed from an optical disc. This is not necessary. In general, the substrates suitable for use with the methods described herein may include any substrate comprising a PC surface.
The methods of the invention are not limited to PC surfaces. By way of non-limiting example, the combination of UV irradiation and provision of an enriched ozone environment may also improve prior art surface activation techniques for polymethylmethacrylate (PMMA), polystyrene (PS), and polydimethylsiloxane (PDMS).
The methods of the invention are not limited to use of activated PC surface with DNA. The surface activation techniques of the invention may be used with other bioassays. By way of non-limiting example, such bioassays may include: protein microarrays, immunoassays (e.g. antibodies and antigens), and carbohydrate/cell microassays.
   Accordingly, the scope of the invention should be interpreted in accordance with the claims appended hereto.

### REFERENCES

(1) Lovrinovic, M.; Niemeyer, C. M. Angew. Chem., Int. Ed. 2005, 44, 3179-3183.
(2) Pirrung, M. Angew. Chem., Int. Ed. 2002, 41, 1276-1289.
(3) Cheung, V. G.; Morley, M.; Aguilar, F.; Massimi, A.; Kucherlapat, R.; Childs, G. Nature Genetics 1999, 21, 15-19.
(4) Dubitsky, A.; Brown, J.; Brandwein, H.; BioTechniques 1992, 13, 392-400.
(5) De Paul, S. M.; Falconnet, D.; Pasche, S.; Textor, M.; Abel, A. P.; Kauffmann, E.; Liedtke, R.; Ehrat, M. Anal. Chem. 2005, 77, 5831-5838.
(6) Johnson, P. A.; Gaspar, M. A.; Levicky, R. J. Am. Chem. Soc. 2004, 126, 9910-9911.
(7) Yu, H. Z. Chem. Commun. 2004, 2633-2636, and references therein.
(8) Madou, M. J.; Lee, L. J.; Daunert, S.; Lai, S.; Shih, C. H. Biomedical Microdevices 2001, 3, 245-254.
(9) Lai, S.; Wang, S.; Luo, J.; Lee, J.; Yang, S. T.; Madou, M. J. Anal. Chem. 2004, 76, 1832-1837 and reference therein.
(10) http://www.amic.se/, accessed on Jun. 19, 2006.
(11) La Clair, J. J.; Eur. Pat. Appl. (2002): 2000-120417 A1.
(12) La Clair, J. J.; U.S. Pat. Appl. Publ. (2004): 2004-797900 A1.
(13) Kido, H.; Maquieira, A.; Hammock, B. D. Anal. Chim. Acta. 2000, 411, 1-11.
(14) Alexander, I.; Houbin, Y.; Collet, J.; Hamels, S.; Demarteau, J.; Gala, J. L.; Remacle, J. BioTechniques 2002, 33, 435-439.
(15) La Clair, J. J.; Burkart, M. D. Org. Biomol. Chem. 2003, 1, 3244-3249.
(16) Varma, M. M.; Inerowicz, H. D.; Regnier, F. E.; Nolte, D. D. Biosensors and Bioelectronics 2004, 19, 1371-1376.
(17) Morais, S.; Marco-Molés, R.; Puchades, R.; Madquieira, Á. Chem. Commun. 2006, 2368-2370.
(18) Yu, H. Z. Anal. Chem. 2001, 73, 4743-4747.
(19) Yu, H. Z.; Rowe, A. W.; Waugh, D. M. Anal. Chem. 2002, 74, 5742-5747.
(20) Helt, J. M.; Drain, C. M.; Batteas, J. D. J. Am. Chem. Soc. 2004, 126, 628-634.
(21) Hazarika, P.; Chowdhury, D.; Chattopadhyay, A. Lab on a Chip 2003, 3, 128-131.
(22) Angnes, L.; Richter, E. M.; Augelli, M. A.; Kume, G. H. Anal. Chem. 2000, 72, 5503-5506.
(23) Daniel, D.; Gutz, I. G. R. Electroanalyis 2001, 13, 681-685.
(24) Westbroek, P.; De Strycker, J.; Dubruel, P.; Temmerman, E.; Schacht, E. H. Anal. Chem. 2002, 74, 915-920.
(25) Wojtyk, J. T. C.; Tomietto, M.; Boukherroub, R.; Wayner, D. D. M. J. Am. Chem. Soc. 2001, 123, 1535-1536.
(26) Delamarche, E.; Bernard, A.; Schmid, H.; Michel, B.; Biebuyck, H. Science 1997, 276, 779-781.
(27) Delamarche, E.; Bernard, A.; Schmid, H.; Bietsch, A.; Michel, B.; Biebuyck, H. J. Am. Chem. Soc. 1998, 120, 500-508.
(28) Liu, Y. J.; Ganser, D.; Schneider, A. Liu, R.; Grodzinski, P.; Kroutchinina, N. Anal. Chem. 2001, 73, 4196-4201.
(29) Liu, Y. J.; Rauch, C. B.; Anal. Biochem. 2003, 317, 76-84.
(30) Welle, A.; Gottwald, E. Biomedical Microdevices 2002, 4, 33-41.
(31) McCarley, R. L.; Vaidya, B.; Wei, S. Y.; Smith, A. F.; Patel, A. B.; Feng, J.; Murphy, M. C.; Soper, S. A. J. Am. Chem. Soc. 2005, 127, 842-843.
(32) Situma, C.; Wang, Y.; Hupert, M.; Barany, F.; McCarley, R. L.; Soper, S. A. Anal. Biochem. 2005, 340, 123-135.
(33) Wei, S.; Vaidya, B.; Patel, A. B.; Soper, S. A.; McCarley, R. L. J. Phys. Chem. B 2005, 109, 16988-16996.
(34) Kimura, N. Biochem. Biophys. Res. Commun. 2006, 347, 477-484.
(35) Xu, Y. C.; Vaidye, B.; Patel, A. B.; Ford, S. M.; McCarley, R. L.; Soper, S. A. Anal. Chem. 2003, 75, 2975-2984.
(36) For an example, see Ishida, T.; Hara, M.; Kojima, I.; Tsuneda, S.; Nishida, N.; Sasabe, H.; Knoll, W. Langmuir 1998, 14, 2092-2096.
(37) Ponter, A. B.; Jones, Jr. W. R.; Jansen, R. H. Polymer Engg. Sci. 1994, 34, 1233-1238.
(38) Holmes-Farley, S. R.; Reamey, R. H.; McCarthy, T. J.; Deutch, J.; Whitesides, G. M. Langmuir 1985, 1, 725-740.
(39) Holmes-Farley, S. R.; Bain, C. D.; Whitesides, G. M. Langmuir 1988, 4, 921-937.
(40) Liu, Y. J.; Navasero, N. M.; Yu, H. Z. Langmuir 2004, 20, 4039-4050.
(41) Rivaton, A. Maihot, B.; Soulestin, J.; Varghese, H.; Gardette, J. L. Polym. Degrad. Stab. 2002, 75, 17-33.
(42) Rivaton, A. Polym. Degrad. Stab. 1995, 49, 163-179.
(43) Hillborg, H.; Tomczak, N.; Olah, A.; Schonherr, H.; Vancso, G. J. Langmuir 2004, 20, 785-794.
(44) Diaz-Quijada, G.; Wayner, D. D. M. Langmuir 2004, 20, 9607-9611.
(45) Teare, D. O. H.; Ton-That, C.; Bradley, R. H. Surf. Interf. Anal. 2000, 29, 276-283.
(46) B. Joos, H. Kuster, R. Cone, Anal. Biochem. 1997, 247, 96-101.
(47) Koch, C. A.; Li, P. C. H.; Utkhede, R. S. Anal. Biochem. 2005, 342, 93-102.
(48) Lee, H. J.; Goodrich, T. T.; Corn, R. M. Anal. Chem. 2001, 73, 5525-5531.
(49) Fixe, F.; Dufva, M.; Telleman, P.; Christensen, C. B. V. Nucleic Acids Res. 1996, 32, e9 (1-8).
(50) Jia, G.; Ma, K.-S.; Kiod, H.; Zoval, J. V.; Madou, M. J. Proceeding of NSTI-Nanotech 2005, vol. 1, p 624-627.
(51) Peng, X. Y.; Li, P. C. H.; Wang, L.; Yu, H. Z.; Parameswaran, M.; Chou, W. L. Proceeding of the 9th International Conference on Miniaturized Systems for Chemistry and Life Sciences 2005, Boston; p 823-825.
(52) Duffy, D. C.; McDonald, J. C.; Schueller, O. J. A.; Whitesides, G. M. Anal. Chem. 1998, 70, 4974-4984.
(53) Huang, Z.; Szostak, J. W. Nucleic Acid Res. 1996, 24, 4360-4361.
(54) Rivaton, A.; Sallet, D.; Lemairs, J. Polym. Photochem. 1983, 3, 463-481.
(55) Factor, A.; Ligon, W. V.; May, R. J. Macromolecules 1987, 20, 2461-2468.
(56) Chen, W.; Neoh, K. G.; Kang, E. T.; Tan, K. L.; Liaw, D. J.; Huang, C. C. J. Poly. Sci. Part A 1998, 36, 357-366.
(57) Kang, E. T.; Neoh, K. G.; Tan, K. L.; Uyama, Y.; Morikawa, N.; Ikada, Y. Macromolecules 1992, 27, 1959-1965.
(58) Burrell, M. C.; Tilley, M. G. J. Vac. Sci. Technol. A 1994, 12, 2507-2514.
(59) Adamson, A. W. Physical Chemistry of Surfaces, Wiley: New York, 1982.
(60) Creager, S. E.; Clarke, J. Langmuir 1994, 10, 3675-3683.
(61) Hozumi, A.; Masuda, T.; Hayashi, K.; Sugimura, H.; Takai, O.; Kameyama, T. Langinuir 2002, 18, 9022-9027.
(62) Su, L.; Sankar, C. G.; Sen, D.; Yu, H. Z. Anal. Chem. 2004, 76, 5953-5959.

1. A method for surface activation of a polymeric surface, the method comprising: providing an ozone enriched environment in a vicinity of the surface; and
irradiating the surface with UV radiation.

2. A method according to claim 1 wherein the surface comprises at least one of: polycarbonate (PC), polymethylmethacrylate (PMMA), polystyrene (PS) and polydimethylsiloxane (PDMS).

3. A method according to claim 1 wherein the surface comprises polycarbonate (PC).

4. A method according to claim 2 wherein providing the ozone enriched environment in a vicinity of the surface comprises providing an ozone enriched environment having an ozone concentration threshold, the ozone concentration threshold greater than a concentration of ozone at the surface of the earth.

5. A method according to claim 4 wherein the ozone concentration threshold is greater than 10 ppm.

6. A method according to claim 2 wherein providing the ozone enriched environment comprises introducing further UV radiation in the vicinity of the surface, the further UV radiation causing molecular oxygen (O₂) to be converted to ozone.

7. A method according to claim 6 wherein the UV radiation for irradiating the surface has a wavelength greater than that of the further UV radiation used to convert molecular oxygen (O₂) to ozone.

8. A method according to claim 7 wherein the UV radiation used to irradiate the surface has a wavelength greater than 240 nm and the further UV radiation used to convert molecular oxygen (O₂) to ozone has a wavelength less than 240 nm.

9. A method according to claim 2 wherein providing the ozone enriched environment comprises generating ozone at a location away from the surface and introducing the generated ozone in the vicinity of the surface.

10. A method according to claim 2 wherein an intensity of the UV radiation used to irradiate the surface is sufficiently low such that a root mean square (RMS) surface roughness of the surface after irradiating the surface with UV radiation is less than twice the RMS surface roughness of the surface prior to irradiating the surface with UV radiation.

11. A method according to claim 2 wherein the intensity of the UV radiation used to irradiate the surface is less than about 50 mW/cm².

12. A method according to claim 6 wherein the combination of the UV radiation used to irradiate the surface and the UV radiation used to convert molecular oxygen (O₂) to ozone has an intensity less than about 50 mW/cm².

13. A method according to claim 3 wherein the surface is the surface of an optical disc and wherein the method comprises removing a reflective layer from the optical disc prior to irradiating the surface with UV radiation.

14. A method according to claim 13 wherein an intensity of the UV radiation used to irradiate the surface is sufficiently low such that data recorded on the optical disc is readable in a conventional optical disc drive after irradiating the surface with UV radiation.

15. A method according to claim 11 wherein irradiating the surface with UV radiation comprises irradiating the surface with UV radiation for a period of less than one hour.

16. A method according to claim 2 comprising allowing a chemical reaction to occur between molecules on the surface and ozone in the ozone enriched environment.

17. A method for conducting a biological assay on a polymeric surface, the method comprising:
activating the surface by providing an ozone enriched environment in a vicinity of the surface and irradiating the surface with UV radiation;
after activating the surface, allowing a first substance to bind to reactive groups on the surface, thereby immobilizing the first substance on the surface;
after immobilizing the first substance on the surface, allowing a second substance to come into contact with surface; and
ascertaining whether there is interaction between the first and second substances.

18. A method according to claim 17 wherein the first substance has known chemical properties and wherein, prior to ascertaining whether there is interaction between the first and second substances, the second substance comprises at least one unknown chemical property which becomes known if there is interaction between the first and second substances.

19. A method according to claim 17 wherein the first substance has known structural properties and wherein, prior to ascertaining whether there is interaction between the first and second substances, the second substance comprises at least one unknown property which becomes known if there is interaction between the first and second substances.

20. A method according to claim 17 wherein at least one of:
(a) the first substance comprises a DNA probe having a known nucleotide sequence and the second substance comprises a DNA target having an at least partially unknown nucleotide sequence;
(b) the first substance comprises one of an antibody and an antigen and the second substance comprises the other one of an antibody and an antigen;
(c) the first and second substances comprise proteins; and
(d) the first substance comprises a carbohydrate molecule and the second substance comprises a cell.

21. A method according to claim 17 wherein the polymeric surface comprises polycarbonate (PC).

22. A method according to claim 21 wherein ascertaining whether there is an interaction between the first and second substances comprises reading the polymeric surface in an optical disc drive.

23. A method for immobilizing a biomolecule on a polymeric surface, the method comprising:
activating the surface by providing an ozone enriched environment in a vicinity of the surface and irradiating the surface with UV radiation;
mounting a mask on the surface, the mask comprising at least one microfluidic channel;
introducing a solution containing the biomolecule to the at least one microfluidic channel;
creating a pressure differential in the at least one microfluidic channel to move the solution through the channel; and
allowing the biomolecule to bind itself to the activated surface.

24. A method according to claim 23 comprising, after allowing the biomolecule to bind itself to the activated surface, passiviting the surface with non-reactive molecules to minimize non-specific binding of other molecules to the surface.

25. A method according to claim 24 wherein the non-reactive molecules comprise glycogen.
